(19) United States
(12) Patent Application Publication
(10) Pub. No.: US 2024/0003205 A1
(43) Pub. Date: Jan. 4, 2024

(54) REDUCING LOSS CIRCULATION DURING WELL-DRILLING OPERATIONS

(71) Applicants: CNPC USA CORPORATION, HOUSTON, TX (US); BEIJING HUAMEI, INC., BEIJING (CN); CHINA NATIONAL PETROLEUM CORPORATION, BEIJING (CN)

(72) Inventors: WEIBIN ZHA, SPRING, TX (US); MENG LU, SUGAR LAND, TX (US); JANINE SHIPMAN, HOUSTON, TX (US); JIAXIANG REN, KATY, TX (US); FUCHEN LIU, PANJIN CITY (CN); RONGCHAO CHENG, BEIJING (CN)

(73) Assignees: CNPC USA CORPORATION, HOUSTON, TX (US); BEIJING HUAMEI, INC., BEIJING (CN); CHINA NATIONAL PETROLEUM CORPORATION, BEIJING (CN)

(21) Appl. No.: 17/810,446

(22) Filed: Jul. 1, 2022

(51) Int. Cl. E21B 21/00; C09K 8/12

(52) U.S. Cl. CPC E21B 21/003; C09K 8/12; C09K 2208/08

(57) ABSTRACT

A method for significantly reducing and/or preventing loss circulation in a well during drilling operations. The method includes pumping water-based drilling fluid comprising shape memory polymer particles into bore hole while drilling and exposing the drilling fluid to an activation temperature. The polymer particles change shape at activation temperature filling all or portion of fractures in the bore hole thus significantly reducing and/or preventing loss circulation in the well.

### TECHNICAL FIELD

This disclosure relates to method for reducing and/or preventing loss circulation in a well during drilling operations comprising shape memory polymer particles.

### BACKGROUND

Natural resources such as oil and gas residing in a subterranean formation or zone are usually recovered by forming a wellbore that extends into the formation. The wellbore is drilled while circulating a drilling fluid therein. The drilling fluid is usually circulated downwardly through the interior of a drill pipe and upwardly through the annulus, which is located between the exterior of the pipe and the walls of the wellbore. After terminating the circulation of the drilling fluid, a string of pipe, e.g., casing, is run in the wellbore. Next, primary cementing is typically performed by pumping cement slurry into the annulus and allowing the cement to set into a hard mass (e.g., sheath). The cement sheath attaches the string of pipe to the walls of the wellbore and seals the annulus.

Often in drilling a wellbore, one or more permeable zones are encountered. The permeable zones may be, for example, unconsolidated, vugs, voids, naturally occurring fractures, or induced fractures that occur when weak zones have fracture gradients exceeded by the hydrostatic pressure of the drilling fluid or the cement slurry. During the drilling operation, the permeable or thief zones may result in the loss of drilling fluid. The drilling fluid flows into the thief zones rather than being returned to the surface, which reduces circulation of the drilling fluid. When circulation is lost, pressure on the open formation is reduced, which can result in an undesired zone flowing into the well or even catastrophic loss of well control.

A large variety of materials have been used or proposed in attempts to reduce and/or prevent loss circulation. Generally, such materials are divided into four types or categories: fibrous materials, such as monofilament synthetic fibers; flaky materials, such as wood chips or mica flakes; granular materials, such as ground marble or petroleum coke; and settable compositions, the relative strength of which increases upon a preplanned mode of triggering after placement, such as hydraulic cement.

Although many materials and compositions exist and have been proposed for preventing lost circulation, there continues to be a need for even more versatile and better compositions and methods for reducing and/or preventing loss circulation. The instant application sets to address the need by incorporating shape memory polymer particles in the drilling fluid and pumping the same into openings such as a fracture, void or pore of a bore hole while drilling.

### SUMMARY

One example of this disclosure is a composition comprising a water-based drilling fluid and shape memory polymer particles, wherein the shape memory polymer particles are in a preprogrammed state having a first shape and change shape to a second shape upon exposure to an activation temperature.

Another example of this disclosure is a method for reducing or preventing loss circulation in a well during drilling operations, the method comprising: (i) drilling a bore hole with a drill bit; (ii) pumping a water-based drilling fluid into fractures of the bore hole while drilling, the water-based drilling fluid comprising shape memory polymer particles, wherein the shape memory polymer particles are in a preprogrammed state, wherein the shape memory polymer particles in the preprogrammed state have a first shape; (iii) exposing the water-based drilling fluid to an activation temperature, wherein exposing to the activation temperature causes the shape memory polymer particles in the preprogrammed state to change shape having a second shape, wherein changing shape from a first shape to a second shape fills all or a portion of the fracture; and (iv) reducing or preventing loss circulation in the well.

The activation temperature in an example described herein can be equal to or higher than glass transition temperature (Tg) of the shape memory polymer particles.

The first shape in an example described herein can be a high aspect ratio shape and the second shape can be a random shape.

The first shape in another example described herein can be a random shape and the second shape can be a high aspect ratio shape.

The shape memory polymer particles in the preprogrammed state, in an example described herein, comprise an average length ranging from 1 millimeter to 10 millimeters.

The change in shape of the shape memory particles, in an example described herein, from a first shape to a second shape does not result in change in volume of the shape memory polymer particles.

The shape memory polymer particles, in an example described herein, can be thermoplastic or thermoset polyurethane fibers comprising a reaction product of a diisocyanate hard block, a polyol soft block, and a chain extender, wherein the polyurethane fibers comprise a glass transition temperature ranging from 50 degrees Centigrade to 250 degrees Centigrade. The polyurethane fibers can further comprise an additive selected from the group consisting of a glass fiber, a carbon fiber, and a carbon nanomaterial. The carbon nanomaterial can be selected from the group consisting of nanotube, nano ball, and nano sheet.

The shape memory polymer particles, in another example described herein, can be epoxy flakes comprising a reaction product of an epoxy resin cured with a curing agent selected from the group consisting of amines, anhydrides, phenols, and thiols, wherein the epoxy flakes comprise a glass transition temperature ranging from 50 degrees Centigrade to 250 degrees Centigrade.

### BRIEF DESCRIPTION OF THE DRAWINGS

FIG. 1 illustrates an example permeability plugging apparatus (PPA) according to aspects disclosed herein.

FIG. 2A shows pre-programmed thermoplastic polyurethane particles before shape change.

FIG. 2B shows pre-programmed thermoplastic polyurethane particles after shape change, e.g., after temperature increase.

FIG. 3A shows pre-programmed thermoset polyurethane particles before shape change.

FIG. 3B shows pre-programmed thermoset polyurethane particles after shape change, e.g., after temperature increase.

FIG. 4 is a side view of a commercially available standard off-the-shelf available testing fixture that is a slot disk containing an opening of 1 inch in length and 4 mm in width.

FIG. 5 is a side view of a commercially available standard off-the-shelf available testing fixture that is a slot disk containing an opening of 1 inch in length and 4 mm in width.

FIG. 6 is a side view of a testing fixture that is a slot disk containing an opening of 1.5 inches in length and 1.3 inches in width at one end.

FIG. 7 shows a tapered long slot of the testing fixture.

FIG. 8 show results of the test conducted as disclosed herein, at room temperature.

FIG. 9 shows results of the test conducted as disclosed herein, at above transition temperature (Tg).

FIG. 10 shows a flowchart of the method of reducing or preventing loss circulation according to one example described herein.

### DETAILED DESCRIPTION

The present disclosure relates to the use shape memory polymer particles, as Loss Circulation Materials (LCMs), in downhole spaces for reducing and/or preventing loss circulation during a wellbore operation. In one example, the disclosure provides apparatus and methods of forming shape-memory polymer particles in suitable shapes and sizes for transportation of such particles to selected spaces in a wellbore, transporting and placing or packing such shaped-memory polymer particles in the selected spaces and activating such placed particles to conform to the selected spaces and allowing certain fluids to flow therethrough while blocking passage of solids of certain sizes present in such fluids.

The shape memory polymer particles can be thermoplastic shape memory polymer particles and/or thermosetting shape memory polymer particles. The thermoplastic shape memory polymer can be selected from the group consisting of: poly(ethylene-co-methacrylic acid), ethylene-methacrylic acid copolymer, polyether ether ketone (PEEK), polypropylene (PP), polystyrene, polyurethane, polynorbornene, polyester, polyether, polyethylene terephthalate (PET), polyethyleneoxide (PEO), poly(1,4-butadiene), polyvinyl acetate), polyamide-6 (nylon-6), poly(tetrahydrofuran), poly(2-methyl-2-oxazoline), poly(ethylene adipate), MDI/1,4-butanediol, poly(c-caprolactone), poly vinyl chloride, polyethylene/polyamide blend, and a combination thereof. The thermosetting shape memory polymer can be selected from the group consisting of epoxy resin, cyanate resin, thermoset polyurethane, polyimide, and polystyrene.

For the purposes of this disclosure a suitable shape memory material is any material that can be maintained in a first form or state having a first shape at a first lower temperature and then changing to a second form or state having a second shape when subjected to a higher temperature. Shape-memory materials of various types are commercially available and are thus not described in detail here.

Examples of the present disclosure provide for loss circulation materials, methods for making loss circulation materials, methods for treating oil and gas well fractures using loss circulation materials, and the like. The examples described herein can be used in reducing or preventing the loss of drilling fluid (loss of circulation) in oil and gas wells during drilling. In particular, the present disclosure can find use in oil and gas wells that have depleted reservoirs, natural and induced fractures, formations with very brittle and/or high porosity, and vugular formations.

Before the examples of the present disclosure are described in detail, it is to be understood that, unless otherwise indicated, the present disclosure is not limited to particular materials, reagents, reaction materials, formation type, manufacturing processes, dimensions, frequency ranges, applications, mud type, specific temperature window or the like, as such can vary. It is also to be understood that the terminology used herein is for purposes of describing examples only and is not intended to be limiting. It is also possible in the present disclosure that steps can be executed in different sequence, where this is logically possible. It is also possible that the examples of the present disclosure can be applied to additional examples involving measurements beyond the examples described herein, which are not intended to be limiting. It is furthermore possible that the examples of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent. A more detailed description of the systems and methods in accordance with the present disclosure is set forth below. It should be understood that the description below of specific devices and methods is intended to be exemplary, and not exhaustive of all possible variations or applications. Thus, the scope of the disclosure is not intended to be limiting and should be understood to encompass variations that would occur to persons of ordinary skill.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients that make up the shape memory polymer particles.

All references to singular characteristics or limitations of examples described herein shall include the corresponding plural characteristic or limitation, and vice-versa, unless otherwise specified or dearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

As used herein, the term “preprogrammed state” refers to the state of the polymer particles obtained using material preprogramming as described herein. At the preprogrammed state, the polymer particles can exist in a high aspect ratio shape or in a random shape.

As used herein, the term “aspect ratio” refers to a proportional relationship between the longest (largest) dimension and the shortest (smallest) dimension of a polymer particle. If the average aspect ratio of all polymer particles is close to 1 (one) and the distribution of the aspect ratio follow normal distribution, such particles are considered to have random shape. If the average aspect ratio of all polymer particles is higher than 2 and the distribution of the aspect ratio follow normal distribution, such particles are considered to have high aspect ratio. As used herein, the term “high aspect ratio shape” refers to the shape of the polymer particles with an average aspect ratio ranging from 2 to 10.

In one example described herein, the term “random shape” refers to any shape that is regular or irregular.

As used herein, the term “activation temperature” refers to a temperature equal to or higher than glass transition temperature (Tg) of the polyurethane or epoxy particles. The glass transition temperature of shape memory particles that can be used according to the examples provided herein can range from 50 degrees Centigrade to 250 degrees Centigrade. Upon exposure to activation temperature, the polymer particles can change their shape from a high aspect ratio shape to a random shape or from a random shape to a high aspect ratio shape. In one example, the activation temperature of the shape memory particles can be 50 degrees Centigrade. In yet another example, the activation temperature of the shape memory particles can be 60 degrees Centigrade.

In yet another example, the activation temperature of the shape memory particles can be 70 degrees Centigrade. In yet another example, the activation temperature of the shape memory particles can be 80 degrees Centigrade. In yet another example, the activation temperature of the shape memory particles can be 90 degrees Centigrade. In yet another example, the activation temperature of the shape memory particles can be 100 degrees Centigrade. In yet another example, the activation temperature of the shape memory particles can be 110 degrees Centigrade. In yet another example, the activation temperature of the shape memory particles can be 120 degrees Centigrade. In yet another example, the activation temperature of the shape memory particles can be 130 degrees Centigrade. In yet another example, the activation temperature of the shape memory particles can be 140 degrees Centigrade. In yet another example, the activation temperature of the shape memory particles can be 150 degrees Centigrade. In yet another example, the activation temperature of the shape memory particles can be 160 degrees Centigrade. In yet another example, the activation temperature of the shape memory particles can be 170 degrees Centigrade. In yet another example, the activation temperature of the shape memory particles can be 180 degrees Centigrade. In yet another example, the activation temperature of the shape memory particles can be 190 degrees Centigrade. In yet another example, the activation temperature of the shape memory particles can be 200 degrees Centigrade. In yet another example, the activation temperature of the shape memory particles can be 210 degrees Centigrade. In yet another example, the activation temperature of the shape memory particles can be 220 degrees Centigrade. In yet another example, the activation temperature of the shape memory particles can be 230 degrees Centigrade. In yet another example, the activation temperature of the shape memory particles can be 240 degrees Centigrade. In yet another example, the activation temperature of the shape memory particles can be 250 degrees Centigrade.

The instant application describes a permeability plugging apparatus (PPA) for testing lost circulation material (LCM). The apparatus may include test chamber, a test cell, and an elongated LCM receiver body. The test chamber comprising a test cell may be coupled with a threaded connection which provides fluid communication between the test chamber and the elongated LCM receiver body. As will be discussed below, LCM testing within the PPA may include testing shape memory particles that are designed or intended to reduce or prevent loss circulation by openings such as a fracture, void, or pore.

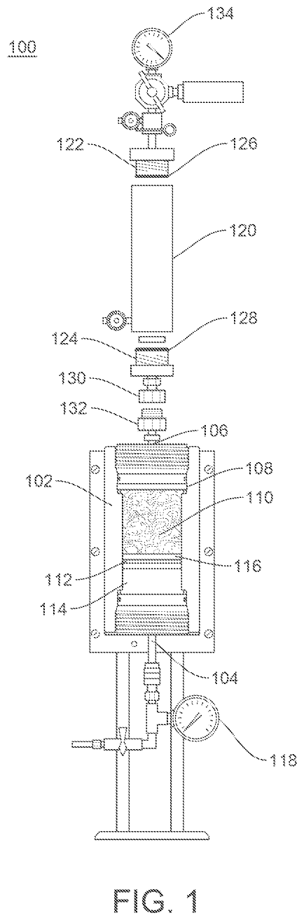

FIG. 1 shows an example of a permeability plugging apparatus (PPA) 100 may be used for testing lost circulation material (LCM). The PPA 100 includes a test chamber 102 with an inlet 104 and an outlet 106. A testing fixture 108 may be removably secured within the test chamber 102 adjacent the outlet 106. The testing fixture 108 has a flowpath therethrough intended to simulate a fracture in a wellbore. In operation, test fluid 110 comprising LCM may be placed in test chamber 102 between the test cell 108 and a slidable piston 112. A pressurization mechanism may be connected, using the hydraulic pump 114, to the PPA cell 100 via the inlet 104. When pressure is applied to the piston 112 by means of the hydraulic pump 114, the test fluid 110 will be placed under pressure causing the test fluid 110 (comprising LCM) travel through the testing fixture 108. O-ring 116 may be disposed within a groove on an outer portion of the piston 112, sealing the portion of the test chamber 102 above the piston 112 from the portion of the test chamber 102 below the piston 112. The PPA 100 includes may include pressure gauge 118, associated with the inlet 104 of the test chamber 102.

The PPA 100 further comprises a cylindrical receiver body 120 with a top cap 122 and a bottom cap 124. The top cap 122 and the bottom cap 124 may be coupled to the cylindrical receiver body 120 via a threaded connection. O-rings 126 and 128 may be disposed at the bottom of the top cap 122 and at the top of the bottom cap 124 sealing the cylindrical receiver body 120 above the bottom cap 124 and below the top cap 122. The cylindrical receiver body 120 may be connected to the outlet 106 of the test chamber 102 via the VCO fitting, female, 130, and the VCO fitting, male, 132. The PPA 100 includes the pressure gauge 134, associated with the top cap 122.

In typical LCM testing scenarios, the width of an opening in a slot disk that makes up the testing fixture 108 may be less than five millimeters. In such instances, the LCM fluids may travel though the slot disk within the testing fixture 108 through outlet 106 and bottom cap 124 into receiver body 120 until the opening in the slot disk become “plugged”, thereby allowing the effectiveness of the LCM fluids to be determined.

According to an example of a method for testing LCMs within a PPA, the method may comprise the step of positioning a slot disk comprising an opening in place of the testing fixture 108 within test chamber 102 of PPA 100. In one example, a slot disk comprising an opening of 1 inch in length and 4 millimeters in width may be used in place of testing fixture 108 within the test chamber. In another example, a slot disk comprising an opening of 1.5 inches in length and 1.3 inches in width at one end and a narrow opening of 1.5 inches in length and 4 mm in width may be used in place of testing fixture 108 within the test chamber. In yet another example, a long tubular structured tapered slot disk comprising an opening of 1.5 inches in length and 4 millimeters in width at one end and 1.5 inches in length and 1 millimeter in width at the other end may be used in place of testing fixture 108 within the test chamber.

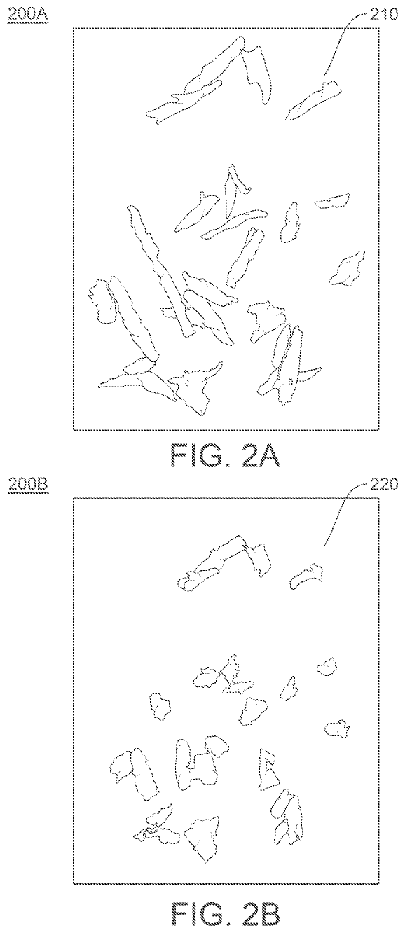

FIG. 2A shows an example of thermoplastic polyurethane shape memory particles 200A as described herein in a preprogrammed state before shape change 210 or at room temperature. The thermoplastic polyurethane shape memory particles exist in a high aspect ratio shape in the preprogrammed state. FIG. 2B shows an example of thermoplastic polyurethane shape memory particles 200B as described herein after change in shape 220, e.g., from high aspect ratio shape to random shape, when the preprogrammed particles are exposed to activation temperature.

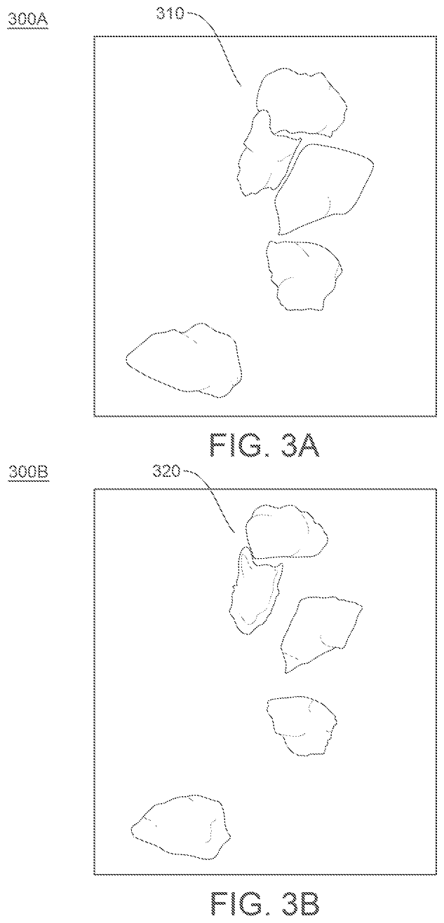

FIG. 3A shows an example of thermoset polyurethane shape memory particles 300A as described herein in a preprogrammed state before shape change 310 or at room temperature. The thermoset polyurethane shape memory particles exist in a high aspect ratio shape in the preprogrammed state. FIG. 3B shows an example of thermoset polyurethane shape memory particles 300B as described herein after change in shape 320, e.g., from high aspect ratio shape to a random shape, when the preprogrammed particles are exposed to activation temperature.

The shape memory particles as described herein can be selected from the group consisting of thermoplastic polyurethane polymer, thermoset polyurethane polymer, and thermoset epoxy polymer. In one example, the polyurethane shape memory polymer particles in the preprogrammed state can be in the form of fibers. In another example, the thermoset epoxy shape memory polymer particles in the preprogrammed state can be in the form of flakes.

In one example, the polyurethane shape memory polymer particles comprise a reaction product of a diisocyanate hard block, a polyol soft block, and a chain extender. In another example, the polyurethane shape memory polymer particles further comprise an additive selected from the group consisting of a glass fiber, a carbon fiber, and a carbon nanomaterial. The carbon nanomaterial can be selected from the group consisting of nanotube, nano ball, and nano sheet.

In yet another example, the epoxy shape memory polymer particles comprise a reaction product of an epoxy resin cured with a curing agent. The curing agent can be selected from the group consisting of amines, anhydrides, phenols, and thiols.

In yet another example disclosed herein, the shape memory particles in the preprogrammed state comprise an average length ranging from 1 millimeter to 10 millimeters. In another example, the shape memory particles in the preprogrammed state comprise an average length ranging from 2 millimeters to 9 millimeters. In yet another example, the shape memory particles in the preprogrammed state comprise an average length ranging from 3 millimeters to 8 millimeters. In yet another example, the shape memory particles in the preprogrammed state comprise an average length ranging from 4 millimeters to 7 millimeters. In yet another example, the shape memory particles in the preprogrammed state comprise an average length ranging from 5 millimeters to 6 millimeters. In yet another example, the shape memory particles in the preprogrammed state comprise an average length of 1 millimeter. In yet another example, the shape memory particles in the preprogrammed state comprise an average length of 2 millimeters. In yet another example, the shape memory particles in the preprogrammed state comprise an average length of 3 millimeters. In yet another example, the shape memory particles in the preprogrammed state comprise an average length of 4 millimeters. In yet another example, the shape memory particles in the preprogrammed state comprise an average length of 5 millimeters. In yet another example, the shape memory particles in the preprogrammed state comprise an average length of 6 millimeters. In yet another example, the shape memory particles in the preprogrammed state comprise an average length of 7 millimeters. In yet another example, the shape memory particles in the preprogrammed state comprise an average length of 8 millimeters. In yet another example, the shape memory particles in the preprogrammed state comprise an average length of 9 millimeters. In yet another example, the shape memory particles in the preprogrammed state comprise an average length of 10 millimeters.

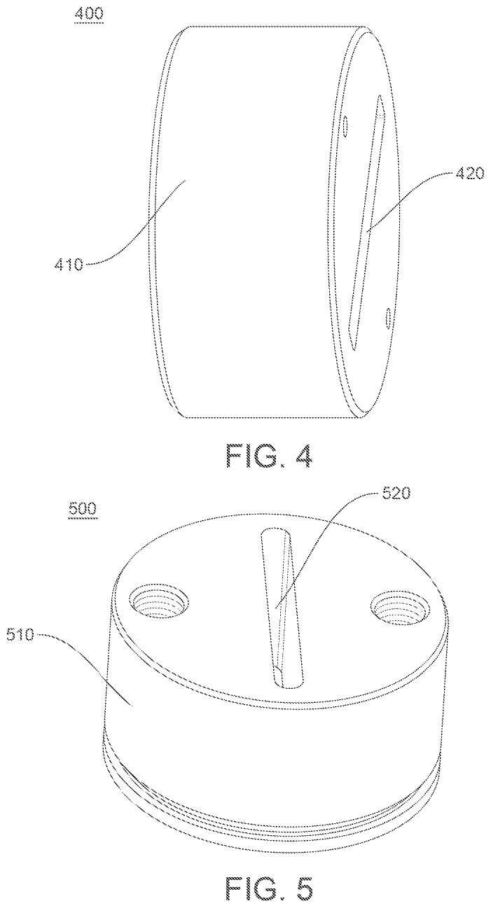

FIG. 4 shows an example of a side view of a commercially available testing fixture 400 that is a slot disk 410 containing an opening 420 that is 1 inch in length and 4 millimeters in width.

FIG. 5 shows an example of the bottom view of the commercially available test fixture 500 that is a slot disk 510 with an opening 520 that is 1 inch in length and 4 millimeters in width.

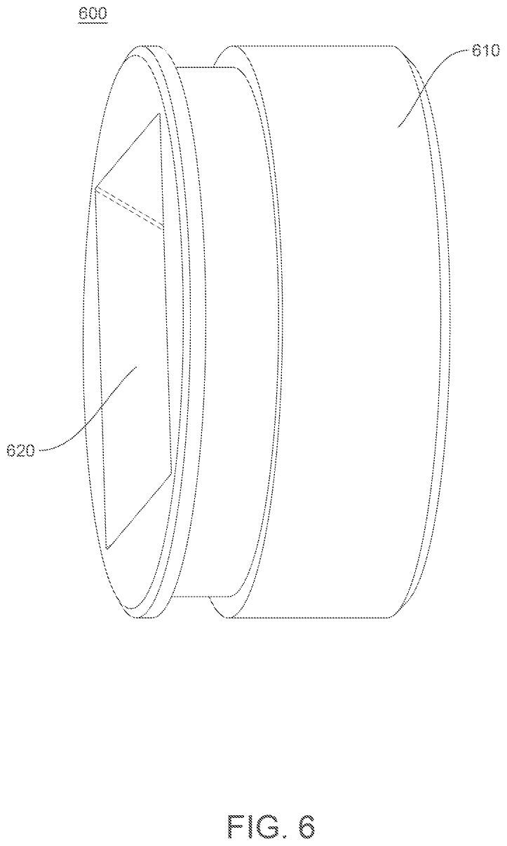

FIG. 6 shows an example of a side view of a testing fixture 600 that is a slot disk 610 containing an opening 620 that is 1.5 inches in length and 1.3 inches in width at one end, designed for the purposes of testing the LCM as described herein.

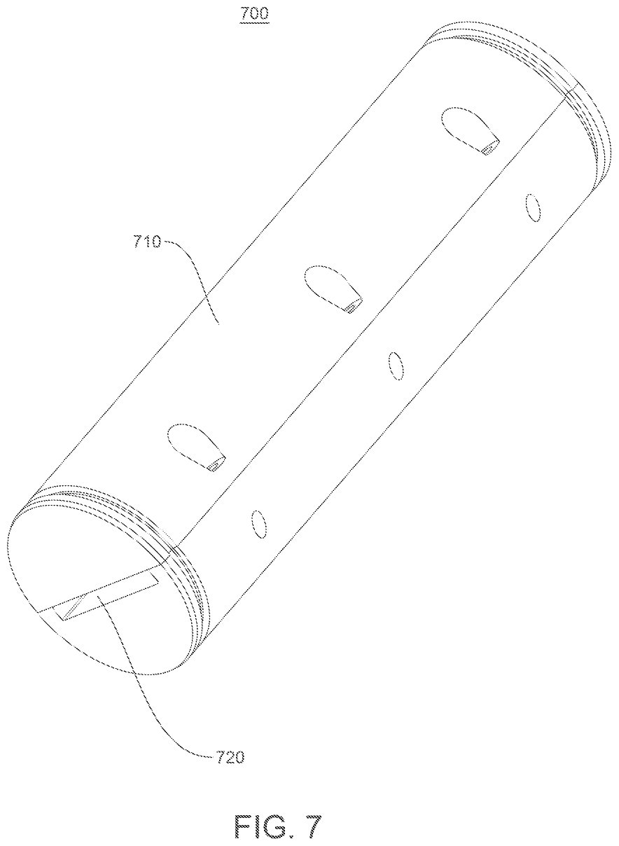

FIG. 7 shows an example of a testing fixture 700 that is a long tubular structured tapered slot disk 710 containing an opening 720 of 1.5 inches in length and 4 millimeters in width opening at one end and 1.5 inches in length and 1 millimeter in width at the other end (not shown in the figure).

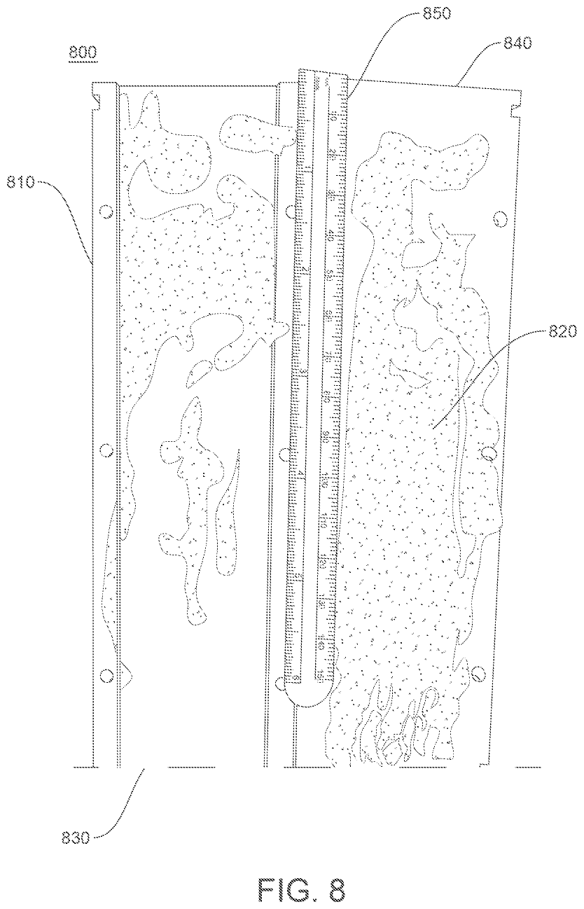

FIG. 8 is a cross section of long tubular tapered slot disk 810 with test fluid 820 therein at room temperature. The test fluid 820 is pumped through opening 830 (that is 1.5 inches in length and 4 millimeters in width) and pushed towards opening 840 (that is 1.5 inches in length and 1 millimeter in width). FIG. 8 demonstrates that, at room temperature, most of test fluid 820 introduced at the 4 millimeters wide opening 830 did not flow to or reach the 1 millimeter wide opening 840. Test fluid 820 stopped at more than an inch away 850 from the 1 millimeter wide opening 840.

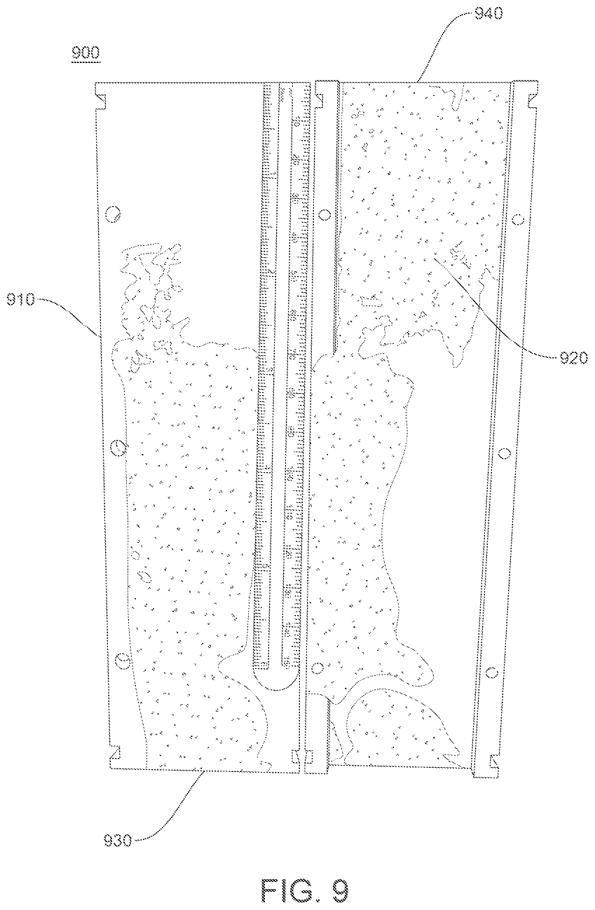

FIG. 9 is a cross section of long tubular tapered slot disk 910 with test fluid 920 therein at increased temperature. The test fluid 920 is pumped through opening 930 (that is 1.5 inches in length and 4 millimeters in width) and pushed towards opening 940 (that is 1.5 inches in length and 1 millimeter in width). FIG. 9 demonstrates that, when the temperature is increased, test fluid 920 introduced at the 4 millimeters wide opening 930 flows to or reaches the 1 millimeter wide opening 940.

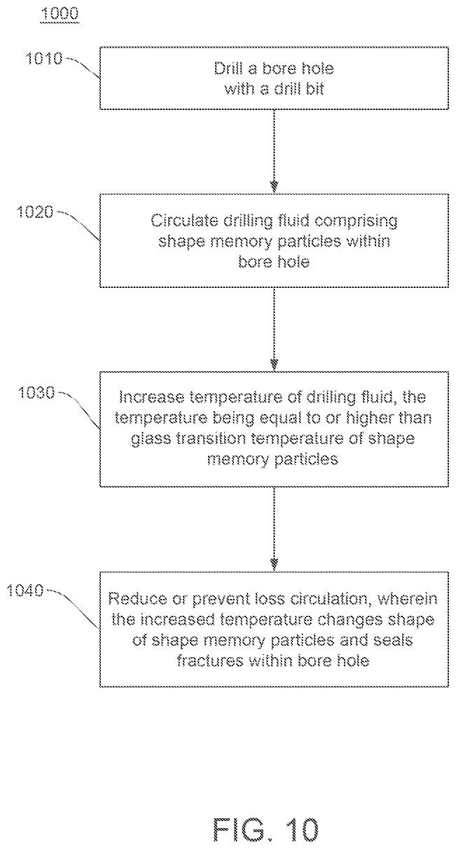

FIG. 10 shows a flow chart of the method 1000 for reducing or preventing loss circulation in a well during drilling operations, the method comprising: (a) drilling a bore hole with a drill bit 1010, (b) pumping a water-based drilling fluid into fractures of the bore hole while drilling, the water-based drilling fluid comprising shape memory polymer particles, wherein the shape memory polymer particles are in a preprogrammed state, wherein the shape memory polymer particles in the preprogrammed state have a first shape; (c) exposing the water-based drilling fluid to an activation temperature, the activation temperature being equal to or higher than glass transition temperature of the shape memory polymer particles, wherein exposing to the activation temperature causes the shape memory polymer particles in the preprogrammed state to change shape having a second shape, wherein changing shape from a first shape to a second shape fills a portion of the fracture; and (d) reducing or preventing loss circulation in the well.

While this specification concludes with claims particularly pointing out and distinctly claiming that, which is regarded as the invention it is anticipated that the invention can be more readily understood through reading the following detailed description of the invention and study of the included examples.

### EXAMPLES

### Example 1: Thermoplastic Polyurethane Shape Memory Polymer Particles

Thermoplastic polyurethane material was first prepared using the process of material preprogramming, wherein (i) thermoplastic polyurethane pellets with glass transition temperature ranging from 70 degrees Centigrade to 90 degrees Centigrade were injection molded into standard sheets, (ii) the sheets were cut into strips, and (iii) the strips were then stretched to 300% thickness at 100 degrees Centigrade followed by cooling the strips to room temperature. After material preprogramming, the stretched strips were cut into smaller pieces with high aspect ratio having an elongated shape as shown in FIG. 2A. The average length of these thermoplastic polyurethane particles ranged from 2 millimeters to 10 millimeters.

As shown in FIG. 2B, the smaller thermoplastic polyurethane pieces with high aspect ratio changed their shape to a more random shape when heated to a temperature of 100 degrees Centigrade on a hot plate.

### Example 2: Thermoset Polyurethane Shape Memory Polymer Particles

Thermoset polyurethane material was first prepared using the process of material preprogramming, wherein (i) thermoset polyurethane sheet having a thickness of about 2 millimeters and a glass transition temperature ranging from 100 degrees Centigrade to 120 degrees Centigrade was casted and cured in an oven, and (ii) compressing the sheet to 50% thickness on a compression molding machine at 135 degrees Centigrade. After material preprogramming, the compressed sheet was cut into smaller particles with high aspect ratio having the shape of a snowflake as shown in FIG. 3A.

As shown in FIG. 3B, the smaller thermoset polyurethane particles with high aspect ratio changed their shape to a more random shape when heated to a temperature of 120 degrees Centigrade on a hot plate.

### Example 3: Loss Circulation Prevention by Shape Memory Particles

Test 1:

A permeability plugging apparatus comprising a test chamber and a commercially available a slot disk with 4 millimeters opening (as shown in FIGS. 4 and 5) was designed to test loss circulation prevention by preprogrammed thermoplastic polyurethane shape memory particles. Water-based drilling fluid comprising the preprogrammed thermoplastic polyurethane shape memory particles (with an average length of 5 millimeters to 6 millimeters) was placed in the test chamber of the permeability plugging apparatus and pumped through the slot disk by means of a pressurization mechanism connected to the test chamber. It was observed that the fluid loss was stopped. However, all particles were stopped at the entrance of the slot and no particles were passed through or present inside the slot to block flow of the fluid. This was because of the high aspect ratio shape (for example, fibrous shape) of the particles. Once the temperature of the fluid was increased to 100 degrees Centigrade, which is above the transition temperature (Tg) of the preprogrammed thermoplastic polyurethane shape memory particles, the flow was not blocked. This was because the particles within the drilling fluid changed shape due to increase in temperature, passed through the opening of the slot disk, and hence did not stop the flow. The size of the particles was decreased to an average of 1.5 millimeters to 2.5 millimeters when the temperature was increased.

Test 2:

A permeability plugging apparatus comprising a test chamber and a slot disk with an opening of 1.5 inches in length and 1.3 inches in width at one end and 1.5 inches in length and 4 millimeters in width at the other end was designed to test preprogrammed thermoplastic polyurethane shape memory particles. The slot disk was placed such that the 2 millimeters opening was towards the test fluid. It was observed that at room temperature the preprogrammed thermoplastic polyurethane shape memory particles with high aspect ratio shape passed through the 2 millimeters opening and accumulated at the 4 mm opening of the slot disc, thus blocking the flow of the fluid. As the temperature of the fluid was increased to about 70 degrees Centigrade to 90 degrees Centigrade, which is above the transition temperature of the preprogrammed thermoplastic polyurethane shape memory particles, the test cell lost pressure but rebuild the pressure (stopped flow) again quickly. This loss and rebuild in pressure were observed twice before the total loss happened demonstrating that the particles can only stop or block the flow in a smaller slot or smaller cracks.

Test 3:

A permeability plugging apparatus comprising a test chamber and a long-tapered slot disk (as shown FIG. 7) was used to test loss circulation prevention of preprogrammed thermoset polyurethane shape memory particles. At room temperature, these particles went into the slot and stopped at about one inch from the narrow opening as show in FIG. 8 and stopped the flow. Once the temperature was increased above transition temperature, all particles changed shape, went into the slot, and reached the end of the slot as shown in FIG. 9. This observation demonstrates that with pre-programmed high aspect ratio shape memory particles, the particles can first stop at the larger cracks and once the temperature increases, these particles can go into smaller cracks and further stop the block the flow thus preventing loss circulation.

Examples of this disclosure also include the following:
4. A method for reducing or preventing loss circulation in a well during drilling operations, the method comprising: drilling a bore hole with a drill bit; pumping a water-based drilling fluid into fractures of the bore hole while drilling, the water-based drilling fluid comprising shape memory polymer particles, wherein the shape memory polymer particles are in a preprogrammed state, wherein the shape memory polymer particles in the preprogrammed state have a first shape; exposing the water-based drilling fluid to an activation temperature, the activation temperature being equal to or higher than glass transition temperature of the shape memory polymer particles, wherein exposing to the activation temperature causes the shape memory polymer particles in the preprogrammed state to change shape having a second shape, wherein changing shape from a first shape to a second shape fills a portion of the fracture; and reducing or preventing loss circulation in the well.
5. The method of example 4, wherein the first shape is a high aspect ratio shape and wherein the second shape is a random shape.
6. The method of example 4, wherein the first shape is a random shape and wherein the second shape is a high aspect ratio shape.
7. The method of example 4, wherein the shape memory polymer particles in the preprogrammed state comprise an average length ranging from 1 millimeter to 10 millimeters.
8. The method of example 4, wherein changing from a first shape to a second shape does not result in change in volume of the shape memory polymer particles.
9. The method of example 4, wherein the shape memory polymer particles comprise polyurethane fibers or epoxy flakes.
10. The method of example 9, wherein the polyurethane fibers are thermoplastic polyurethane fibers or thermoset polyurethane fibers.
11. The method of example 9, wherein the polyurethane fibers comprise a glass transition temperature ranging from 50 degrees Centigrade to 250 degrees Centigrade.
12. The method of example 9, wherein the polyurethane fibers comprise a reaction product of: a diisocyanate hard block, a polyol soft block, and a chain extender.
13. The method of example 12, wherein the polyurethane fibers further comprise an additive selected from the group consisting of a glass fiber, a carbon fiber, and a carbon nanomaterial.
14. The method of example 12, wherein the carbon nanomaterial is selected from the group consisting of nanotube, nano ball, and nano sheet.
15. The method of example 9, wherein the epoxy flakes are thermoset epoxy flakes.
16. The method of example 15, wherein the epoxy flakes comprise a glass transition temperature ranging from 50 degrees Centigrade to 250 degrees Centigrade.
17. The method of example 9, wherein the epoxy flakes comprise a reaction product of an epoxy resin cured with a curing agent selected from the group consisting of amines, anhydrides, phenols, and thiols.

Although the polymers and processing methodologies of the present disclosure have been described with reference to specific exemplary embodiments thereof, the present disclosure is not to be limited to such exemplary embodiments. Rather, as will be readily apparent to persons skilled in the art, the teachings of the present disclosure are susceptible to many implementations and/or applications, without departing from the scope of the present disclosure. Indeed, modifications and/or changes in the selection of specific polymers, polymer ratios, processing conditions, and end-use applications are contemplated hereby, and such modifications and/or changes are encompassed within the scope of the present invention as set forth by the claims which follow.

1. A method for reducing or preventing loss circulation in a well during drilling operations, the method comprising:
drilling a bore hole with a drill bit;
pumping a water-based drilling fluid into fractures of the bore hole while drilling, the water-based drilling fluid comprising shape memory polymer particles, wherein the shape memory polymer particles are in a preprogrammed state, wherein the shape memory polymer particles in the preprogrammed state have a first shape;
exposing the water-based drilling fluid to an activation temperature, the activation temperature being equal to or higher than glass transition temperature of the shape memory polymer particles, wherein exposing to the activation temperature causes the shape memory polymer particles in the preprogrammed state to change shape having a second shape, wherein changing shape from a first shape to a second shape fills a portion of the fracture; and
reducing or preventing loss circulation in the well, and
wherein changing from the first shape to the second shape does not result in change in volume of the shape memory polymer particles.

2. The method of claim 1, wherein the first shape is a high aspect ratio shape and wherein the second shape is a random shape, and wherein high aspect ratio shape refers to an average aspect ratio ranging from 2 to 10.

3. The method of claim 1, wherein the first shape is a random shape and wherein the second shape is a high aspect ratio shape, and wherein high aspect ratio shape refers to an average aspect ratio ranging from 2 to 10.

4. The method of claim 1, wherein the shape memory polymer particles in the preprogrammed state comprise an average length ranging from 1 millimeter to 10 millimeters.

5. (canceled)

6. The method of claim 1, wherein the shape memory polymer particles comprise polyurethane fibers.

7. The method of claim 6, wherein the polyurethane fibers are thermoplastic polyurethane fibers or thermoset polyurethane fibers.

8. The method of claim 6, wherein the polyurethane fibers comprise a glass transition temperature ranging from 50 degrees Centigrade to 250 degrees Centigrade.

9. The method of claim 6, wherein the polyurethane fibers comprise a reaction product of:
a diisocyanate hard block,
a polyol soft block, and
a chain extender.

10. The method of claim 9, wherein the polyurethane fibers further comprise an additive selected from the group consisting of a glass fiber, a carbon fiber, and a carbon nanomaterial.

11. The method of claim 9, wherein the carbon nanomaterial is selected from the group consisting of nanotube, nano ball, and nano sheet.

12. The method of claim 6, wherein the shape memory polymer particles comprise epoxy flakes, and wherein the epoxy flakes are thermoset epoxy flakes.

13. The method of claim 12, wherein the epoxy flakes comprise a glass transition temperature ranging from 50 degrees Centigrade to 250 degrees Centigrade.

14. The method of claim 6, wherein the shape memory polymer particles comprise epoxy flakes, and wherein the epoxy flakes comprise a reaction product of an epoxy resin cured with a curing agent selected from the group consisting of amines, anhydrides, phenols, and thiols.
